(19) United States
(12) Patent Application Publication
(10) Pub. No.: US 2011/0112884 A1
(43) Pub. Date: May 12, 2011

(54) Method and Apparatus for Determining Appropriate Health Care Staffing

(75) Inventor: Sadie Roth, Cuyahoga Falls, OH (US)

(73) Assignee: Children's Hospital Medical Center of Akron, Akron, OH (US)

(21) Appl. No.: 12/615,484

(22) Filed: Nov. 10, 2009

(51) Int. Cl. G06Q 10/00; G06Q 90/00

(52) U.S. Cl. 705/7.25; 705/500

(57) ABSTRACT

Provided is a method for making a schedule of a first number of people needed to staff a health care department for a first time period. The method may comprise defining a first time period, defining a second time period, providing admission numbers, providing residence numbers, predicting a total admission number for the second time period, predicting admission numbers for each of a plurality of acuity levels for the first time period, predicting residence numbers for each acuity level for the first time period, predicting the first number of people, and outputting a schedule of the first number of people in the first time period.

### TECHNICAL FIELD

Provided are a staffing schedule, method and apparatus for determining appropriate staffing levels. More particularly, provided are a health care staffing schedule, method and apparatus for determining appropriate health care staffing levels. More particularly, provided are a method and an apparatus for predicting the number of health care workers needed to staff an emergency room.

### BACKGROUND

Schedules are common in many industries. In some industries, including, but not limited to, health care industries, appropriate worker scheduling, is a priority. Inappropriate worker scheduling can comprise overstaffing or understaffing. Overstaffing may result in higher operating costs. Understaffing may result in being unable to provide the needed services or products. Inability to provide the needed services or products can result in undesirable complications or consequences in a health care environment. It remains desirable to predict appropriate worker requirements over time in order to properly produce a schedule for health care workers.

### SUMMARY

Provided is a method for making a schedule of a first number of people needed to staff a health care department for a first time period. The method may comprise defining a first time period, defining a second time period, providing admission numbers, providing residence numbers, predicting a total admission number for the second time period, predicting admission numbers for each of a plurality of acuity levels for the first time period, predicting residence numbers for each acuity level for the first time period, predicting the first number of people, and outputting a schedule of the first number of people in the first time period.

Also provided is an apparatus for making a schedule of a first number of people needed to staff a health care department for a first time period. The apparatus may comprise, a component adapted to store data sufficient to define a first time period, a component adapted to store data sufficient to define a second time period, a component adapted to accept provided admission numbers, a component adapted to accept provided residence numbers, a component adapted to process data to predict a total admission number for the second time period, a component adapted to process data to predict admission numbers for each of a plurality of acuity levels for the first time period, a component adapted to process data to predict residence numbers for each acuity level for the first time period, a component adapted to process data to predict the first number of people, and a component adapted to output a schedule of the first number of people in the first time period. The second time period may include the first time period. Admission numbers may be the number of people admitted to the health care department. Residence numbers may be numbers of people admitted to the health care department and who have not been discharged from the health care department. A component adapted to process data to predict a total admission number for the second time period may be adapted to perform operations upon admission numbers from a time prior to said second time period. A component adapted to process data to predict admission numbers for each of a plurality of acuity levels for the first time period may be adapted to perform operations upon admission numbers for a plurality of acuity levels for a time prior to said first time period, and upon said total admission numbers for the second time period. A component adapted to process data to predict residence numbers for each acuity level for the first time period may be adapted to perform operations upon admission numbers for a plurality of acuity levels for a time prior to said first time period, and upon residence numbers for each acuity level for first time period. A component adapted to process data to predict the first number of people may be adapted to perform operations upon admission numbers for a plurality of acuity levels for the first time period, upon residence numbers for each acuity level for first time period, and upon the number of people needed to staff a health care department for a prior time period.

### BRIEF DESCRIPTION OF THE DRAWINGS

The present subject matter may take form in certain parts and arrangement of parts, embodiments of which will be described in detail in this specification and illustrated in the accompanying drawings which form a part hereof, and wherein:

FIG. 1 is a depiction of one embodiment of a utility to determine a staffing level and output the resulting schedule.

FIG. 2 is a depiction of another embodiment of a utility to determine a staffing level and output the resulting schedule.

FIG. 3 is a depiction of another embodiment of a utility to determine a staffing level and output the resulting schedule.

FIG. 4 is a flow chart depicting steps of one embodiment of a method to determine a schedule.

FIG. 5 is a depiction of one embodiment of an electronic computer.

### DETAILED DESCRIPTION

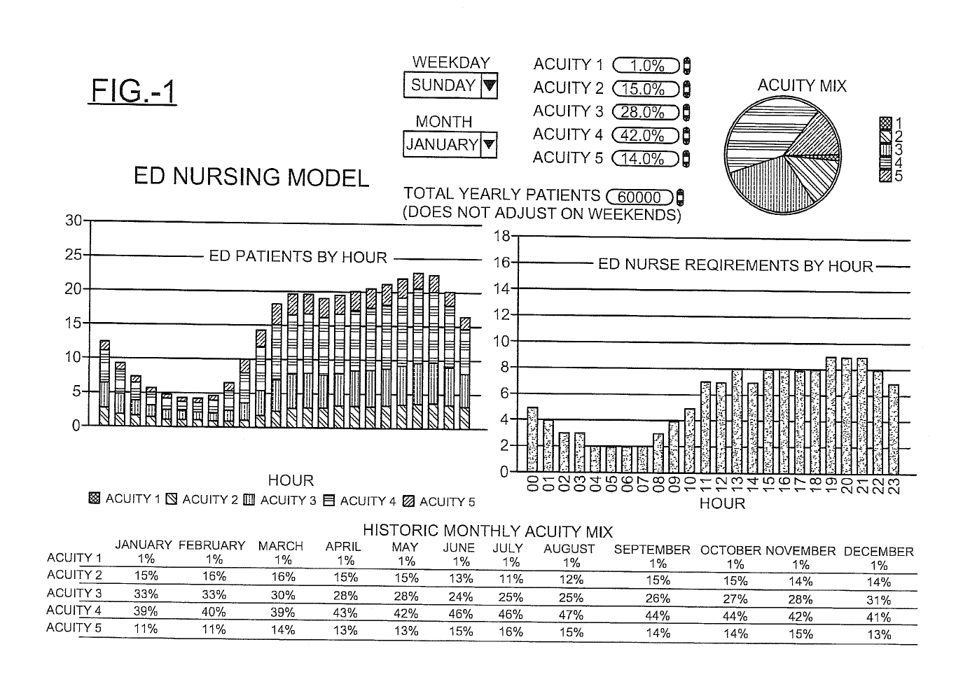

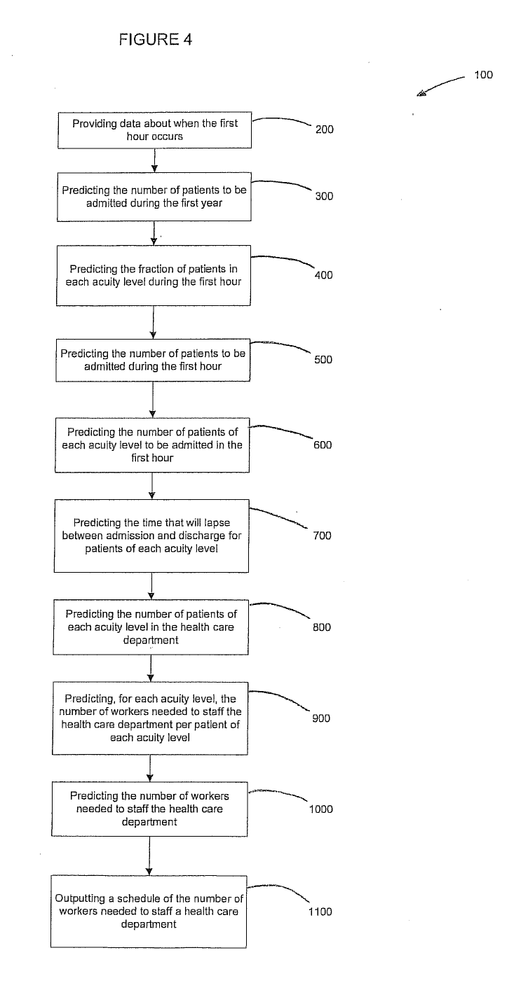

Reference will be made to the drawing, FIGS. 1-5, wherein the showings are only for purposes of illustrating certain embodiments of a health care staffing schedule, method and apparatus for determining appropriate health care staffing levels, and not for purposes of limiting the same. Specific characteristics relating to the embodiments disclosed herein are not to be considered as limiting, unless the claims expressly state otherwise.

A schedule or method or apparatus for determining a scheduling requirement for the number workers needed to staff a health care department may be directed toward the scheduling of workers for any sort of health care department. In certain embodiments, and without limitation, a health care department may comprise an emergency room, or other medical care facility or department. As used herein, unless otherwise noted, an emergency room is a health care facility adapted to provide treatment to patients with a broad spectrum of health problems, comprising life-threatening health problems and health problems requiring immediate attention. Unless otherwise noted, the term emergency room is equivalent to ER, emergency department, ED, emergency ward, accident & emergency department, and casualty department.

Schedules describe scheduling requirements. Scheduling requirements may be described in a number of ways. In certain embodiments, and without limitation, scheduling requirements may be described by the number of workers needed during a particular shift, or by the number of workers needed during a particular hour, or by the number of staff workers needed during any other time period. In certain embodiments, workers may be described more particularly by the nature of the work they perform or may be described by licensure, certification, duty, or other qualification. Without limitation, in certain embodiments, workers may comprise registered nurses, LPN, BSN, nurse anesthetists, triage or flow coordinators, or nurses aides.

As used herein, unless otherwise noted, a month may refer to any particular month of the year, such as, January, February, March, April, May, June, July, August, September, October, November, and December. Specifying when a particular month, such as a first month, occurs comprises specifying a particular year; for example, and without limitation, June of 2009.

As used herein, unless otherwise noted, a weekday may refer to any particular day of the week, such as, Sunday, Monday, Tuesday, Wednesday, Thursday, Friday, and Saturday. Specifying when a particular weekday, such as a first weekday, occurs comprises specifying a first month and/or a first year; for example, and without limitation, Mondays in June of 2009.

As used herein, unless otherwise noted, hour may refer to a particular time of day independent of the particular day. That is, for example, the 0100 hour is not specific to any day; every day has a 0100 hour. As used herein, 24 hour notation will be used such that the 0100 hour refers to the hour beginning one hour after midnight, the 0200 hour refers to the hour beginning two hours after midnight, and so forth. Data about events or metrics for an hour may be taken for that hour everyday giving, without limitation, and for illustration only, seven samples a week. Some events occur with daily frequency such that they occur at approximately similar hours each day. In certain embodiments, specifying when a first hour occurs comprises specifying a first weekday, a first month, and a first year; for example, and without limitation, the 0100 hour on Mondays in June of 2009.

As used herein, unless otherwise indicated, a computer may comprise an electronic computer, an electromechanical computer, or a mechanical computer. An electronic computer may comprise any electronic digital computer. Electromechanical computers may comprise, without limitation, a relay ladder logic system. Mechanical computers may comprise, without limitation, an adding machine, an abacus, and a slide rule.

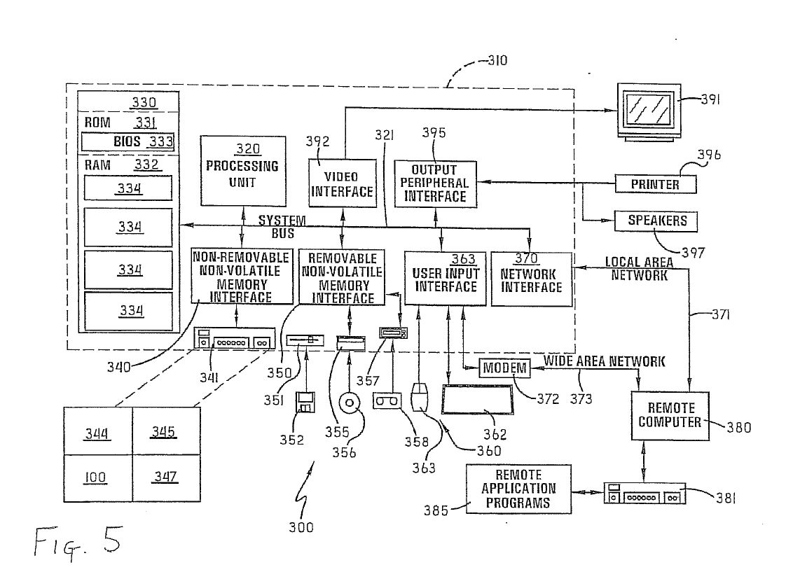

With reference now to FIG. 5, an example of a suitable computing platform environment 300 for implementing the automated reconfiguration system 100 according to one embodiment is illustrated. The computing platform environment 300 is only one non-limiting example of a suitable computing platform environment and is not intended to suggest any limitation as to the scope of use or functionality of the automated reconfiguration system 100. Neither should the computing platform environment 300 be interpreted as having any dependency or requirement relating to any one or combination of components illustrated in the exemplary operating computing platform environment 300. The automated reconfiguration system 100 is operational with numerous other general purpose or special purpose computing platform environments or configurations. Examples of well known computing platforms, environments, and/or configurations that may be suitable for use with the automated reconfiguration system 100 include, but are not limited to, personal computers, server computers, hand-held or laptop devices, multiprocessor systems, microprocessor-based systems, program logic controllers (PLC), remote terminal units (RTU), data concentrators, system control and data acquisition (SCADA) devices, programmable consumer electronics, network PCs, minicomputers, mainframe computers, distributed computing environments that include any of the above systems or devices, and the like. The automated reconfiguration system 100 may be described in the general context of computer-executable instructions, such as program modules, being executed by a computer. Generally, program modules include routines, programs, objects, components, data structures, etc. that perform particular tasks or implement particular abstract data types. The automated reconfiguration system 100 may also be practiced in distributed computing platform environments where tasks are performed by remote processing devices that are linked through a communications network or other data transmission medium. In a distributed computing platform environment, program modules and other data may be located in both local and remote computer storage media including memory storage devices.

With continued reference to FIG. 5, according to one embodiment, a system for implementing the automated reconfiguration system 100 includes a general purpose computing system or platform in the form of a computing platform 310. The computing platform 310 may include a plurality of computer system components including, but not limited to, a processing unit 320, a memory portion 330, and a system bus 321. The system bus 321 may couple various system components including the memory portion 330 to the processing unit 320. The system bus 321 may be any of several types of bus structures including a memory bus or memory controller, a peripheral bus, and a local bus using any of a variety of bus architectures chosen with sound judgment by a person of ordinary skill.

With continued reference to FIG. 5, the computing platform 310 may include a plurality of computer readable media. The computer readable media can be any available media that can be accessed by the computing platform 310 and includes both volatile and nonvolatile media, removable and non-removable media. By way of example, and not limitation, the computer readable media may comprise computer storage media and communication media. Computer storage media includes both volatile and nonvolatile, removable and non-removable media implemented in any method or technology for storage of information such as computer readable instructions, data structures, program modules or other data. Computer storage media includes, but is not limited to, RAM, ROM, EEPROM, flash memory or other memory technology, CDROM, digital versatile disks (DVD) or other optical disk storage, magnetic cassettes, magnetic tape, magnetic disk storage or other magnetic storage devices, or any other medium which can be used to store the desired information and which can accessed by the computing platform 310. Communication media typically embodies computer readable instructions, data structures, program modules or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media. The computing platform 310 may comprise any of the computer readable media or any combination of computer readable chosen with sound judgment by a person of ordinary skill in the art.

With continued reference to FIG. 5, the memory portion 330 may include computer storage media in the form of volatile and/or nonvolatile memory such as read only memory (ROM) 331 and random access memory (RAM) 332. The computing platform 310 may comprise a basic input/output system 333 (BIOS). The BIOS 333 may contain the basic routines that at least partially enable the transfer of information between the plurality of system components within the computing platform 310. The BIOS 333 may be stored in the ROM 331. The RAM 332 may contain data and/or program modules 334 that are immediately accessible to and/or presently being operated on by the processing unit 320. Additionally, the computing platform 310 may also include other removable/non-removable, volatile/nonvolatile computer storage media. The computing platform 310 may comprise a hard disk drive 340, a magnetic disk drive 351, a nonvolatile magnetic disk drive 352, an optical disk drive 355, and/or a sequential media drive 357. The hard disk drive 340 may read from or write to a non-removable, nonvolatile magnetic media. The magnetic disk drive 351 may read from or write to a removable, nonvolatile magnetic disk 352. The optical disk drive 355 may read from or write to a removable, nonvolatile optical disk 356, such as a CD ROM or other optical media. The sequential media drive 357 may read from or write to a removable, nonvolatile sequential medium 358, such as a magnetic tape cassette or reel-to-reel tape. Other removable/non-removable, volatile/nonvolatile computer storage media that can be used may include, but are not limited to, flash memory cards, digital versatile disks, digital video tape, solid state RAM, solid state ROM, and any other type of computer storage media chosen with sound judgment by a person of ordinary skill in the art. The hard disk drive 341 may be connected to the system bus 321 through a non-removable memory interface such as interface 340. The magnetic disk drive 351 and the optical disk drive 355 may be connected to the system bus 321 by a removable memory interface, such as interface 350.

With continued reference to FIG. 5, the drives and their associated computer storage media discussed above may provide storage of computer readable instructions, data structures, program modules and other data for the computing platform 310. In one embodiment, the hard disk drive 341 may be used to store an operating system 344, application programs 345, the automated reconfiguration system 100, as well as other data 347. The computing platform 310 may comprise a plurality of input devices 360 that allow a user to enter commands and information into the computing platform 310. The plurality of input devices 360 may include input devices such as a keyboard 362 and a pointing device 361 (commonly referred to as a mouse, trackball or touch pad) or any other input device chosen with sound judgment by a person of ordinary skill in the art. The plurality of input devices 360 may be connected to the processing unit 320 through a user input interface 363. The user input interface 363 may be coupled to the system bus 321. The computing platform 310 may comprise a plurality of output devices 390. The plurality of output devices 390 may include a display device 391, an audio speaker system 197, and a printer device 396. The display device 391 may be connected to the system bus 321 via a video interface 392. The audio speaker system 397 and the printer device 396 may be connected to the system bus 321 via an output peripheral interface 395.

With continued reference to FIG. 5, the computing platform 310 may operate in a networked environment using logical connections to one or more remote computing platforms, such as a remote computing platform 380. The remote computing platform 380 may be a personal computer, a server, a router, a network PC, a peer device or other common network node. The remote computing platform 380 may include many or all of the components described above relative to the computing platform 310. The logical connections to the remote computing platform 380 may include a remote memory storage device 381, a local area network (LAN) 371 and a wide area network (WAN) 373. The logical connections to the remote computing platform 380 may include any other network or logical connection chosen with sound judgment by a person of ordinary skill in the art. When used in a LAN networking environment, the computing platform 310 may be connected to the LAN 371 through a network interface or adapter 370. When used in a WAN networking environment, the computing platform 310 may include a modem device 372 or other means for establishing communications over the WAN 373, such as the Internet, chosen with sound judgment by a person of ordinary skill in the art. The modem device 372, may be and internal or external modem device and may be connected to the system bus 321 via the user input interface 363. In a networked environment, program modules used for operating the automated reconfiguration system 100, or portions thereof, may be stored in the remote memory storage device 381. Additionally, remote application programs 185 for enabling the remote operation or execution of the automated reconfiguration system 100 may be stored on the remote memory storage device 381.

As noted above, data may be provided to or read from a computer in a variety of ways. In certain embodiments, data may be provided to a computer by a data input device. Without limitation, a data input device may comprise a keyboard, a mouse, a storage medium, a code reader, a dial or slide, or a physical data indicator. In some embodiments, provided data may comprise historical data. In certain embodiments, data may be output from a computer by a data output device. Without limitation, a data output device may comprise a monitor, a printing device, a storage medium, a dial or slide, or a physical data indicator. In certain embodiments a physical data indicator may comprise a state of magnetization, a state of a switch, a state of a relay, a needle, dial, wheel, gear, bead, or bubble.

A computer may fit a model to data provided to it using regression. In some embodiments, a computer may be programmed or otherwise adapted to fit a model to provided data using forward stepwise multiple linear regression. In some embodiments, a computer may be programmed or otherwise adapted to extrapolate a model to obtain a predicted data.

As used herein, unless otherwise indicated, linear regression is a form of regression analysis in which the relationship between an independent variable and a dependent variable, is modeled using a least squares function.

Historical data is data about past events. Historical data may be provided by taking it from record keeping or similar action. In certain embodiments, historical data may span hours, days, weeks, months, years, or different periods of time. Historical data need not be continuous.

Predicted data is data about future events. Without limitation, predicted data comprises estimations, projections, and forecasts about future values or events. In some embodiments, predicted data may be provided by prediction methods using historical data. Without limitation, and for sake of illustration only, predicted data about the number of patients to expect to be admitted into an emergency room during a future 0100 hour may be created from historical data of the number of patients admitted into an emergency room during the 0100 hour.

Without limitation, data may comprise, an admission number. An admission number is the number of people admitted to the health care department. Admission numbers can be specific to a particular time period, such as, without limitation, admission numbers for a particular year or month. Admission numbers can also be specific to a particular kind of patient. Without limitation, and for sake of illustration only, one kind of admission number may be admission numbers for acuity 1 during July 2008; that is, all the patients of acuity level 1 admitted in July of 2008.

Without limitation, data may comprise, a residence number. A residence number is the number of people admitted to the health care department and who have not been discharged from the health care department. That is, the residence number gives the number of people in the health care department. Residence numbers can be specific to a particular time period, such as, without limitation, residence numbers for a particular year or month. Residence numbers can also be specific to a particular kind of patient. Without limitation, and for sake of illustration only, one kind of residence number may be residence numbers for acuity 1 during the 0100 hour of Jul. 31, 2009.

Because people may not be discharged in the same time period in which they are admitted, some people admitted in a first time period will remain in the health care department until some later time period. The residence number for a particular time period need not be the same as the admission number. Generally, the residence number will either be equal to or higher than the admission number for a particular time period.

Without limitation, one prediction method to create predicted data from historical data is by taking an average of the historical data and use the resulting average as the projected data. In some embodiments, taking an average of the historical data may be done by taking arithmetic mean, a harmonic mean, a geometric mean, a root mean square, a median, a midpoint, a mode, or any type of average. Without limitation, and for sake of illustration only, projected data about the number of patients to expect to be admitted into an emergency room during the 0100 hour may be created from an arithmetic average of historical data of the number of patients admitted into an emergency room during the 0100 hour. In some embodiments, an electronic computer, an electromechanical computer, or a mechanical computer is used for taking an average or otherwise conducting the processing needed to create projected data from historical data.

Without limitation, another prediction method to create predicted data from historical data is by fitting a model to the historical data, extrapolating the model to cover future events, and using the extrapolated data about the future events from the model as predicted data. Without limitation, in some embodiments one way to fit a model to historical data may be by regression analysis. In certain embodiments a regression analysis may comprise linear regression, logistic regression, or probit regression. In some embodiments, linear regression is forward stepwise multiple linear regression. Without limitation, and for sake of illustration only, predicted data about the number of patients to expect to be admitted into an emergency room during the 0100 hour may be created by 1) fitting a model to the historical data of the number of patients admitted into an emergency room during the 0100 hour by linear regression, where said model yields a number of patients as a function of time, and 2) extrapolating to a future time by inputting future time of interest into said model and taking the resultant number of patients as the predicted data about the number of patients to expect to be admitted into an emergency room during said future time of interest. In some embodiments, an electronic computer, an electromechanical computer, or a mechanical computer is used for performing the regression analysis, fitting the model, extrapolating the model, or otherwise conducting the processing needed to create predicted data from historical data.

As used herein, unless otherwise noted, patients are individuals seeking the services of a health care worker or on whose behalf the services of a health care worker is sought. Without limitation, a patient may comprise an injured individual, an individual having sickness, illness, or disease, an individual having an allergic reaction, an individual having pain, an individual in labor or giving birth, an individual having unease, an individual having a health-related complaint, an individual having non-specific symptoms, or an individual having psychosomatic symptoms. A patient may also include an individual, healthy or otherwise, seeking the services of a health care worker under false or misleading pretenses. As used herein, unless otherwise noted, a patient is any person admitted to a health care department.

In some health care settings, such as, without limitation, emergency rooms, each patient is sorted into one of a plurality of groups corresponding to the severity of the patient's condition or the promptness of care the patient requires. In certain embodiments, such sorting may comprise triage. In certain embodiments, such sorting may comprise division into acuity groups.

Without limitation, in those health care settings in which patients are sorted into acuity groups, all patients will have an acuity. As used herein, a patient's acuity refers to the acuity group in which the patient belongs. In certain embodiments of health care settings in which patients are sorted into acuity groups, there may be five groups. Acuity 1 represents the group of patients having the greatest care needs. Acuity 2 represents the group of patients having care needs less than Acuity 1, but greater than Acuity 3. Acuity 3 represents the group of patients having care needs less than Acuity 2, but greater than Acuity 4. Acuity 4 represents the group of patients having care needs less than Acuity 3, but greater than Acuity 5. Acuity 5 represents the group of patients having the least care needs. In those health care settings in which patients are sorted into acuity groups, in any set of patients, there will be some definable fraction of patients of each acuity group, ranging from 0 to 1, and the sum of the fraction of patients in each acuity group across all acuity groups is 1.

In some embodiments, the fraction of patients in each acuity group may be expressed as a percentage. For example, and without limitation, as shown in FIG. 1, 1.0% of patients are in acuity group 1; 15.0% of patients are in acuity group 2; 28.0% of patients are in acuity group 3; 42.0% of patients are in acuity group 4; and 14.0% of patients are in acuity group 5. The total of all five percentages is 100%; all patients are in one of the five acuity groups.

Referring now to FIGS. 1-4, one embodiment of a method for making a schedule of the number workers needed to staff a health care department 100 is depicted. A method for making a schedule of the number workers needed to staff a health care department 100 may comprise: providing data about when the first hour occurs 200, said data including a first year; predicting the number of patients to be admitted 300 during the first year, said patients each being of some acuity level; predicting the fraction of patients in each acuity level 400 during the first hour; predicting the number of patients to be admitted 500 during the first hour; predicting the number of patients of each acuity level to be admitted 600 in the first hour; predicting the time that will lapse between admission and discharge for patients of each acuity level 700; predicting the number of patients of each acuity level in the health care department 800 during the first hour; predicting, for each acuity level, the number of workers needed to staff the health care department per patient of each acuity level 900; predicting the number of workers needed to staff the health care department 1000 in the first hour; and outputting a schedule of the number of workers needed to staff a health care department 1100 in the first hour. The order in which these processes are listed is not intended to be limiting; the order shown is only one non-limiting embodiment.

Many different kinds of apparatus may be used to perform the processes of a method for making a schedule of the number workers needed to staff a health care department 100. Without limitation one apparatus for making a schedule of the number of workers needed to staff a health care department during a first hour may comprise, a component adapted to accept provided data about when the first hour occurs; a component adapted to process data to generate a predicted number of patients to be admitted during the first year; a component adapted to process data to generate a predicted fraction of patients in each acuity level during the first hour; a component adapted to process data to generate a predicted number of patients to be admitted during the first hour; a component adapted to process data to generate a predicted number of patients of each acuity level to be admitted in the first hour; a component adapted to process data to generate a predicted time that will lapse between admission and discharge for patients of each acuity level; a component adapted to process data to generate a predicted number of patients of each acuity level in the health care department during the first hour; a component adapted to process data to generate a predicted number of workers, for each acuity level, needed to staff the health care department per patient of each acuity level; a component adapted to process data to generate a predicted number of workers needed to staff the health care department in the first hour; and a component adapted to output a schedule of the number of workers needed to staff a health care department in the first hour. Without limitation an apparatus for making a schedule of the number of workers needed to staff a health care department during a first hour may comprise a computer, a data input device, and a data output device. In some embodiments, provided data comprises historical data.

In some embodiments, a plurality of processes involve an adaptation to process data to generate a predicted number or an adaptation to process data to generate a predicted fraction, or an adaptation to process data to generate a predicted time. Such adaptations may comprise a program or other adaptation to fit a model to provided data using forward stepwise multiple linear regression. In some embodiments, a computer may be programmed or otherwise adapted to extrapolate a model to obtain a predicted data.

Without limitation, the embodiment shown comprises providing data about when the first hour occurs 200. In some embodiments, data about when the first hour occurs may comprise a first weekday, a first month, or a first year. The first weekday, comprises the weekday in which the first hour occurs. The first month, comprises the month in which the first hour occurs. The first year, comprises the year in which the first hour occurs. For example, and without limitation, a particular time of interest, a first hour, may be described as the 0100 hour on Mondays in May during 2009.

Without limitation, the embodiment shown comprises predicting the number of patients to be admitted 300 during the first year. The first year may be specified as described in step 200. Without limitation, in some embodiments, predicting the number of patients to be admitted during first year 300 may be done by providing historic data sufficient to predict the number of patients expected to be admitted into the health care department during the first year and predicting data to form an prediction of the number of patients to be admitted into the health care department during the first year by any of the prediction methods described above. Without limitation, in some embodiments historic data sufficient to predict the number of patients expected to be admitted into the health care department during the first year may comprise data about the number of patients admitted into the health care department during one or more prior years.

In some embodiments, data about the number of patients admitted into the health care department during one or more previous years is processed to yield a model describing the number of patients admitted into the health care department as a function of the year. In certain embodiments, a linear regression model is extrapolated forward to predict a number of patients expected to be admitted into the health care department during the first year.

Without limitation, the embodiment shown comprises the step of predicting the fraction of patients in each acuity level 400 during the first hour. The first hour may be specified as described in step 200. Without limitation, in some embodiments, predicting the fraction of patients in each acuity level 400 during the first hour is done by providing historical data sufficient to predict the fraction of patients in each acuity level during the first hour, and processing the data to predict the fraction of patients in each acuity level during the first hour by any of the prediction methods described above.

Historical data sufficient to predict the fraction of patients in each acuity level during the first hour may comprise data about the number of patients admitted into the health care department and their respective acuities during the same hour on different weekdays, or in different months, or in different years. Without limitation, in some embodiments historical data sufficient to predict the fraction of patients in each acuity level during the first hour comprises data about the number of patients admitted into the health care department and their respective acuities during the same hour of the same weekday of different months or different years. For example and without limitation, historical data sufficient to predict the fraction of patients in each acuity level during the 0100 hour on Mondays in May of 2009 may include data taken from the 0100 hour on Mondays in May of 2008, 2007, and 2006.

Without limitation, the embodiment shown comprises predicting the number of patients to be admitted 500 during the first hour. The first hour may be specified as described in step 200. Without limitation, in some embodiments, predicting the number of patients to be admitted 500 during the first hour, may be done by providing historical data about the number of patients admitted into the health care department and the time of their admission; and processing the data to predict the number of patients to expect to be admitted into the health care department in the first hour by any of the prediction methods described above.

Without limitation, in some embodiments historical data about the number of patients admitted into the health care department and the time of their admission comprises data spanning weeks, months, or years.

Without limitation, the embodiment shown comprises predicting the number of patients of each acuity level to be admitted 600 in the first hour. The first hour may be specified as described in step 200. Without limitation, in some embodiments, predicting the number of patients of each acuity level to be admitted 600 in the first hour may be done by taking the product at each acuity level of 1) the predicted number of patients to be admitted during the first hour as generated by predicting the number of patients to be admitted 500 during the first hour and 2) the fraction of patients in each acuity level as generated by predicting the fraction of patients in each acuity level 400 during the first hour.

Without limitation, the embodiment shown comprises predicting the time that will lapse between admission and discharge for patients of each acuity level 700. Without limitation, in some embodiments, predicting the time that will lapse between admission and discharge for patients of each acuity level 700 may be done by providing historical data sufficient to determine time lapse between admission and discharge for patients of each acuity level, and processing the data to predict time that will lapse between admission and discharge for patients of each acuity level by any of the prediction methods described above. Historical data sufficient to determine time lapse between admission and discharge for patients of each acuity level may comprise historical data about patients comprising, for each patient, the acuity level of the patient, the admission time of the patient, and the discharge time of the patient. In certain embodiments, a separate model will be generated for each acuity level. In certain embodiments, a model will produce average time until discharge as a function of one or more of the year, month, weekday, hour, and acuity.

Without limitation, the embodiment shown comprises predicting the number of patients of each acuity level in the health care department 800 during the first hour. Without limitation, in some embodiments, predicting the number of patients of each acuity level in the health care department 800 during the first hour may be done by taking, for each acuity level, the number of patients for that acuity level previously admitted and not discharged, adding the number of patients predicted to be admitted for that acuity level from step 600, and subtracting the number of patients discharged for that acuity level.

In some embodiments, and for some acuity levels, the prediction of the time that will lapse between admission and discharge for patients of the acuity level from step 700 may be 1 hour; patients are discharged at the end of the hour, so that the number of patients to expect to be in the health care department in the first hour 800 is equal to the number resulting from predicting the number of patients of the acuity level to be admitted in the first hour in step 600.

In some embodiments, and for some acuity levels, the prediction of the time that will lapse between admission and discharge for patients of the acuity level from step 700 may be 2 hours. Patients are discharged at the end of the hour following the hour of admission; the number of patients of the acuity level to expect to be in the health care department in the first hour 800 may be found by taking the number resulting from predicting the number of patients of the acuity level to be admitted in the first hour in step 600, and adding the number resulting from predicting the number of patients of the acuity level to be admitted one hour prior to the first hour. Predicting the number of patients of the acuity level to be admitted one hour prior to the first hour is analogous to predicting the number of patients of the acuity level to be admitted in the first hour in step 600.

In some embodiments, the prediction of the time that will lapse between admission and discharge for patients of K acuity level is N hours, the number of patients of K acuity level to expect to be in the health care department in the first hour is equal to the number resulting from predicting the number of patients of the acuity level to be admitted in the first hour in step 600 plus the sum of the numbers resulting from predicting the number of patients of K acuity level to be admitted in each hour prior to the first hour through an hour N−1 hours prior to the first hour.

Without limitation, the embodiment shown comprises predicting the average number of workers needed to staff the health care department per patient of each acuity level 900. Without limitation, in some embodiments, the average number workers needed to staff a health care department per patient of each acuity level 900 may be determined by reference to some standard. Without limitation, in some embodiments, the standard used to determine the average number workers needed to staff a health care department per patient of each acuity level may be a standard provided by a professional organization or standards organization, such as the Emergency Nurses Association.

In some embodiments, and without limitation, there are five acuity levels. The average number of workers needed to staff the health care department for each patient of acuity level 1 is three (3) workers. The average number of workers needed to staff the health care department for each patient of acuity level 2 is two-thirds (⅔) of a worker. The average number of workers needed to staff the health care department for each patient of acuity level 3 is one-third (⅓) of a worker. The average number of workers needed to staff the health care department for each patient of acuity level 4 is one-quarter (¼) of a worker. The average number of workers needed to staff the health care department for each patient of acuity level 5 is one-fifth (⅕) of a worker.

Without limitation, the embodiment shown comprises predicting the number of workers needed to staff the health care department 1000 in the first hour. Without limitation, in some embodiments, predicting the number of workers needed to staff the health care department 1000 in the first hour may be done by summing across all acuity levels the number of workers needed to staff the health care department for each acuity level in the first hour.

For each acuity level, the number of workers needed to staff the health care department in the first hour may be found by taking the product of the number predicted in the step of predicting the average number of workers needed to staff the health care department per patient of each acuity level 900 and the number resulting from predicting the number of patients of each acuity level in the health care department 800 in the first hour.

Without limitation, the embodiment shown comprises outputting a schedule of the number of workers needed to staff a health care department 1100 in the first hour. Without limitation, in some embodiments, outputting a schedule of the number of workers needed to staff a health care department 1100 in the first hour may be done by rounding the number predicted in the step of predicting the number of workers needed to staff the health care department 1000 in the first hour, up to the next integer and outputting the resulting integer as a scheduling requirement for the first hour. Outputting may be display to a screen, a printout, a transmission to a cell phone, a transmission to a PDA, a transmission to another remote electronic device, or by output through any other kind of output device.

Referring now to FIG. 1, without limitation, shown is a schedule for workers at a particular ED showing, among other matters, that from 0000 to 0100 hours on Sundays during the month of January, 5 nurses should be on staff in the ED. Without limitation, the utility shown in FIG. 1 is a computer input and output interface allowing a user to input data used by a scheduling program to determine scheduling requirements. The input data may comprise the weekday, the month, percentages of patients in each of five acuity levels summing to 100%, and total yearly patients. Without limitation, the utility shown in FIG. 1 shows scheduling data displaying the number of nurses that should be on staff in the ED for each hour of the weekday and month shown. Without limitation, the utility shown in FIG. 1 shows data displaying the predicted number of patients by acuity level in the ED for each hour of the weekday and month shown.

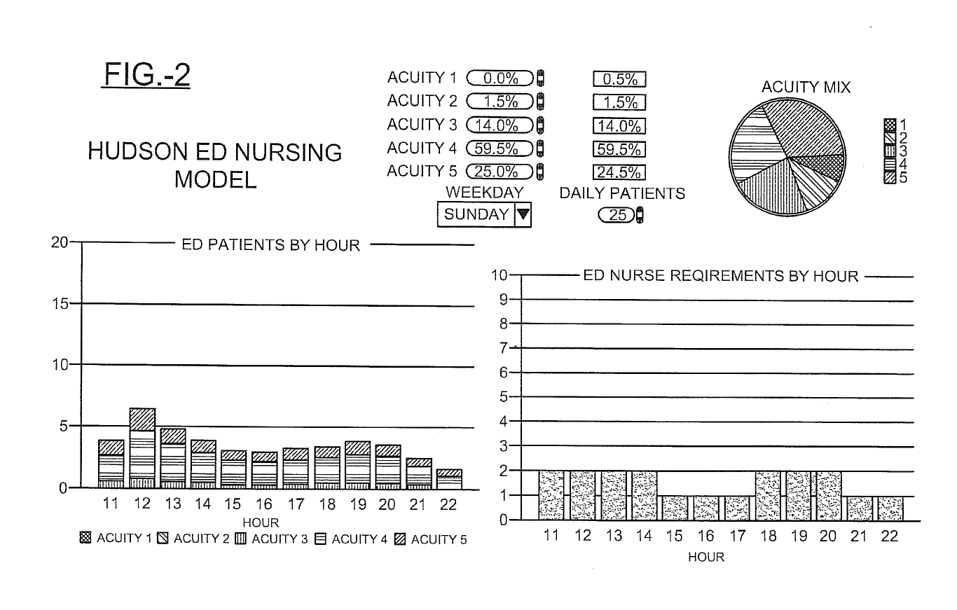

Referring now to FIG. 2, without limitation, shown is a schedule for workers showing, among other matters, that during hour 11 on Sundays, 2 nurses should be on staff in the ED. Without limitation, the utility shown in FIG. 2 is a computer input and output interface allowing a user to input data used by a scheduling program to determine scheduling requirements. The input data may comprise the weekday, percentages of patients in each of five acuity levels summing to 100%, and daily patients. Without limitation, the utility shown in FIG. 2 shows scheduling data displaying the number of nurses that should be on staff in the ED for each hour of the weekday shown. Without limitation, the utility shown in FIG. 2 shows data displaying the predicted number of patients by acuity level in the ED for each hour of the weekday shown.

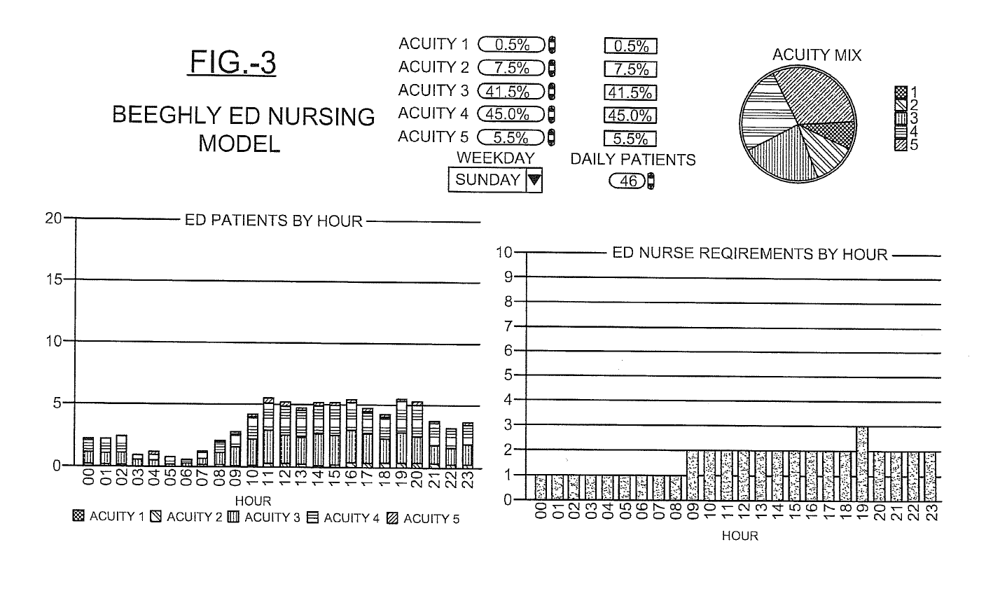

Referring now to FIG. 3, without limitation, shown is a schedule for workers showing, among other matters, that from 1900 to 2000 hours on Sundays, 3 nurses should be on staff in the ED. Without limitation, the utility shown in FIG. 3 is a computer input and output interface allowing a user to input data used by a scheduling program to determine scheduling requirements. The input data may comprise the weekday, percentages of patients in each of five acuity levels summing to 100%, and daily patients. Without limitation, the utility shown in FIG. 3 shows scheduling data displaying the number of nurses that should be on staff in the ED for each hour of the weekday shown. Without limitation, the utility shown in FIG. 3 shows data displaying the predicted number of patients by acuity level in the ED for each hour of the weekday shown.

While the basic time unit referenced in the above disclosed embodiments is an hour, the methods and apparatuses disclosed work equally well with any time unit. That is, the health care staffing schedule, method and apparatus for determining appropriate health care staffing levels can be used to schedule workers during a given hour, half-hour, minute, or any other time unit.

While the health care staffing schedule, method and apparatus for determining appropriate health care staffing levels has been described above in connection with the certain embodiments, it is to be understood that other embodiments may be used or modifications and additions may be made to the described embodiments for performing the same function of the health care staffing schedule, method and apparatus for determining appropriate health care staffing levels without deviating therefrom. Further, the health care staffing schedule, method and apparatus for determining appropriate health care staffing levels may include embodiments disclosed but not described in exacting detail. The present subject matter could be applied to any scheduling matter wherein staffing levels are dependent upon predictable needs, events, or customers. Non-limiting examples would include the scheduling of operators in call centers, clerks or cashiers in retail environments, and mail or package sorters in post offices or parcel delivery services. Further, all embodiments disclosed are not necessarily in the alternative, as various embodiments may be combined to provide the desired characteristics. Variations can be made by one having ordinary skill in the art without departing from the spirit and scope of the health care staffing schedule, method and apparatus for determining appropriate health care staffing levels. Therefore, the health care staffing schedule, method and apparatus for determining appropriate health care staffing levels should not be limited to any single embodiment, but rather construed in breadth and scope in accordance with the recitation of the attached claims.

What is claimed is:

1. A method for making a schedule of a first number of people, the first number of people being the number of people needed to staff a health care department for a first time period, the method comprising:
defining a first time period;
defining a second time period, where said second time period includes said first time period;
providing admission numbers, where said admission numbers are numbers of people admitted to the health care department;
providing residence numbers, where said residence numbers are numbers of people admitted to the health care department and who have not been discharged from the health care department;
predicting a total admission number for the second time period, said predicting comprising,
performing operations upon admission numbers from a time prior
to said second time period;
predicting admission numbers for each of a plurality of acuity levels for the first time period, said predicting comprising,
performing operations upon admission numbers for a plurality of acuity levels for a time prior to said first time period, and upon said total admission number for the second time period;
predicting residence numbers for each acuity level for the first time period, said predicting comprising,
performing operations upon admission numbers for a plurality of acuity levels for a time prior to said first time period, and upon residence numbers for each acuity level for first time period;
predicting the first number of people, said predicting comprising,
performing operations upon admission numbers for a plurality of acuity levels for the first time period, upon residence numbers for each acuity level for first time period, and upon the number of people needed to staff a health care department for a prior time period; and
outputting a schedule of the first number of people in the first time period.

2. The method of claim 1, wherein said predicting admission numbers for each of a plurality of acuity levels for the first time period comprises,
predicting the total admission number for the first time period;
predicting, for each acuity level, the fraction of persons in the total admission number in that acuity level during the first time period; and
generating an admission number for each acuity level by taking the product, for each acuity level, of the fraction of people in that acuity level during the first time period and total admission number for the first time period.

3. The method of claim 2, wherein said predicting residence numbers for each acuity level for the first time period comprises,
predicting the residence time for each acuity level;
determining the initial number of people of each acuity level in the health care department using said residence time for that acuity level; and
summing, for each acuity level, the admission number and the initial number.

4. The method of claim 3, wherein said predicting the first number of people comprises,
predicting, for each acuity level, the number of people needed to staff the health care department per person in that acuity level;
predicting the number of people needed to staff the health care department during the first time period for each acuity level, by taking the product of the residence number for that acuity level and the number of people needed to staff the health care department per person in that acuity level; and
summing the number of people needed to staff the health care department during the first time period for each acuity level across all acuity levels.

5. The method of claim 4, wherein said predicting admission numbers for each of a plurality of acuity levels for the first time period comprises,
predicting the total admission number for the first time period, said predicting comprising,
providing historical data,
fitting a model to said data, and
extrapolating said model to obtain the predicted the total admission number for the first time period
predicting, for each acuity level, the fraction of persons in the total admission number in that acuity level during the first time period, said predicting comprising,
providing historical data,
fitting a model to said data, and
extrapolating said model to obtain the predicted fraction of persons in the total admission number in that acuity level during the first time period; and
generating an admission number for each acuity level by taking the product, for each acuity level, of the fraction of people in that acuity level during the first time period and total admission number for the first time period.

6. The method of claim 5, wherein said predicting residence numbers for each acuity level for the first time period comprises,
predicting the residence time for each acuity level, said predicting comprising,
providing historical data,
fitting a model to said data, and
extrapolating said model to obtain the predicted residence time for each acuity level;
determining the initial number of people of each acuity level in the health care department using said residence time for that acuity level; and
summing, for each acuity level, the admission number and the initial number.

7. The method of claim 6, wherein said predicting the first number of people comprises,
predicting, for each acuity level, the number of people needed to staff the health care department per person in that acuity level, said predicting comprising,
providing historical data,
fitting a model to said data, and
extrapolating said model to obtain the predicted number of people needed to staff the health care department per person in that acuity level;
predicting the number of people needed to staff the health care department during the first time period for each acuity level, by taking the product of the residence number for that acuity level and the number of people needed to staff the health care department per person in that acuity level; and
summing the number of people needed to staff the health care department during the first time period for each acuity level across all acuity levels.

8. The method of claim 7, wherein fitting a model comprises using a computer to fit a model using regression.

9. The method of claim 8, wherein said regression comprises forward stepwise multiple linear regression.

10. The method of claim 9, wherein
said health care department is an emergency room; and
said people needed to staff a health care department are nurses, doctors, or medical technicians.

11. An apparatus for making a schedule of a first number of people, the first number of people being the number of people needed to staff a health care department for a first time period, the apparatus comprising:
a component adapted to store data sufficient define a first time period;
a component adapted to store data sufficient to define a second time period, where said second time period includes said first time period;
a component adapted to accept provided admission numbers, where said admission numbers are numbers of people admitted to the health care department;
a component adapted to accept provided residence numbers, where said residence numbers are numbers of people admitted to the health care department and who have not been discharged from the health care department;
a component adapted to process data to predict a total admission number for the second time period, said component adapted to
perform operations upon admission numbers from a time prior to said second time period;
a component adapted to process data to predict admission numbers for each of a plurality of acuity levels for the first time period, said component adapted to,
perform operations upon admission numbers for a plurality of acuity levels for a time prior to said first time period, and upon said total admission numbers for the second time period;
a component adapted to process data to predict residence numbers for each acuity level for the first time period, said component adapted to,
perform operations upon admission numbers for a plurality of acuity levels for a time prior to said first time period, and upon residence numbers for each acuity level for first time period;
a component adapted to process data to predict the first number of people, said component adapted to,
perform operations upon admission numbers for a plurality of acuity levels for the first time period, upon residence numbers for each acuity level for first time period, and upon the number of people needed to staff a health care department for a prior time period; and
a component adapted to output a schedule of the first number of people in the first time period.

12. The apparatus of claim 11, wherein said component adapted to process data to predict admission numbers for each of a plurality of acuity levels for the first time period comprises an electronic computer

13. The apparatus of claim 12, wherein said component adapted to process data to predict residence numbers for each acuity level for the first time period comprises an electronic computer

14. The apparatus of claim 13, wherein said component adapted to process data to predict the first number of people comprises an electronic computer.

15. The apparatus of claim 14, wherein said electronic computer comprises,
a component adapted to accept provided historical data,
a component adapted to fit a model to said data, and
a component adapted to extrapolating said model to obtain a prediction.

16. The apparatus of claim 15, wherein said component adapted to fit a model to said data is adapted to fit a model using regression.

17. The apparatus of claim 16, wherein said component adapted to fit a model to said data is adapted to fit a model using forward stepwise multiple linear regression.

18. The apparatus of claim 17, wherein said component adapted to output a schedule comprises a monitor, screen, printer, or plotter.

19. The apparatus of claim 18, wherein said health care department is an emergency room.

20. The apparatus of claim 19, wherein said people needed to staff a health care department are nurses, doctors, or medical technicians.
